(19) United States
(12) Patent Application Publication
(10) Pub. No.: US 2026/0269734 A1
(43) Pub. Date: Sep. 10, 2026

(54) EV Battery Charger DC/DC Bidirectional Converter with Hybrid Resonant Frequency and Phase Shift Modulation Charge Mode Control and Dual Active Bridge Discharge Mode Control

(71) Applicant: Schaeffler Technologies AG & Co. KG, Herzogenaurach (DE)

(72) Inventors: Daniel William Shafer, Mussey Twp., MI (US); Justin Hanson, Auburn Hills, MI (US); Mikhail Zarkhin, Nokomis, FL (US)

(73) Assignee: Schaeffler Technologies AG & Co. KG, Herzogenaurach (DE)

(21) Appl. No.: 19/560,373

(22) Filed: Mar. 9, 2026

Related U.S. Application Data
(60) Provisional application No. 63/769,724, filed on Mar. 10, 2025.

(51) Int. Cl. H02M 3/335; H02M 1/00; H02M 3/00

(52) U.S. Cl. CPC H02M 3/33584; H02M 1/0019; H02M 1/0058; H02M 3/015; H02M 3/33573

(57) ABSTRACT

A bidirectional series-resonant power converter including a transformer; an asymmetrical resonant tank electrically coupled to the transformer; a primary side inverter electrically coupled to a primary side of the transformer; the primary side inverter including primary side switches, wherein the resonant tank including at least a series resonant capacitor at the primary side, a secondary side rectifier electrically coupled to a secondary side of the transformer, the secondary side rectifier including secondary side switches, wherein the resonant tank further comprises at the secondary side of the transformer, a coupling inductance to facilitate energy storage enabling soft switching and bidirectional power flow, and a controller configured to control the primary side and secondary side switches to operate the converter in a charge mode by regulating a power flow in a first power flow direction and a discharge mode by regulating a power flow in a second power flow direction.

### CROSS REFERENCE TO RELATED APPLICATION

This application claims priority from U.S. Provisional Application No. 63/769,724, filed on Mar. 10, 2025.

### TECHNICAL FIELD

The disclosure relates to bidirectional DC-DC power converters suitable for applications including, but not limited to, electric vehicle (EV) battery chargers and energy storage systems.

### BACKGROUND

Bidirectional power conversion is fundamental to modern energy systems, including electric vehicle (EV) battery chargers and renewable energy storage applications, where efficient and reliable energy transfer in both directions is required. EV battery packs typically operate at high voltages in the range of approximately 400 to 850 volts and require conversion from the AC power grid to DC voltage for charging. Conversely, these large DC energy storage systems can also operate in reverse to supply power back to AC loads, such as providing emergency backup power to homes during outages, powering construction sites lacking utility access, or supplementing peak load demand on the electric grid.

A widely adopted topology for enabling bidirectional power flow with galvanic isolation and voltage scaling between DC domains is the Dual Active Bridge (DAB) converter. Conventional DAB converters comprise a primary full-bridge inverter and a secondary full-bridge inverter interconnected by an isolation transformer.

While conventional DAB converters provide efficient bidirectional power transfer, they have inherent limitations. The coupling inductance can give rise to substantial circulating reactive currents that impose conduction losses and increased thermal stress on power components. Maintaining zero voltage switching (ZVS) across a broad range of input and output voltages requires careful phase and timing adjustments. At extreme voltage or load conditions, converters may experience hard switching transitions, leading to elevated switching losses, electromagnetic interference, and reduced device lifetime. Furthermore, the reliance on symmetrical coupling inductance and fixed switching frequency restricts the flexibility of voltage regulation and constrains potential improvements in power density and efficiency.

Thus, there is a need to provide a DC/DC converter including wide voltage range and light load operation, high power density, and high efficiency.

### SUMMARY

An objective of the invention is to fulfill the need referred to above. In accordance with the principles of an embodiment, this objective is achieved by A bidirectional series-resonant power converter including a transformer; an asymmetrical resonant tank electrically coupled to the transformer; a primary side inverter electrically coupled to a primary side of the transformer; the primary side inverter including a plurality of primary side switches, wherein the resonant tank including at least a resonant capacitor (Cr) exclusively at the primary side, a secondary side rectifier electrically coupled to a secondary side of the transformer, the secondary side rectifier including a plurality of secondary side switches, wherein the resonant tank further comprises at the secondary side of the transformer, a coupling inductance to facilitate energy storage enabling soft switching and bidirectional power flow, and a controller configured to control the primary side and secondary side switches to operate the converter in 1) a charge mode by regulating a power flow in a first power flow direction from the primary side to the secondary side and 2) a discharge mode by regulating a power flow in a second power flow direction from the secondary side to the primary side.

In accordance with another aspect of an embodiment, a method operates the full-bridge primary side inverter and the full bridge secondary side rectifier at a nominal 50% duty cycle with a transistor dead-time t_{d} introduced between complementary gate signals to facilitate zero voltage switching (ZVS).

### DESCRIPTION OF THE DRAWINGS

FIG. 1 is a schematic view of an electric vehicle with a conventional charging system.

FIG. 2 is a schematic view of a prior art implementation of an isolated CLLC bidirectional DC/DC converter with integrated leakage and magnetizing inductances.

FIG. 3 is a schematic view of an exemplary bidirectional DC/DC converter with LLC resonant frequency modulation control in charge direction and Dual Active bridge control in discharge direction, in accordance with an embodiment of the invention.

FIG. 4 is a transistor gate switching diagram in a forward power LLC frequency modulation mode showing the outer phase angle relationship between the primary and secondary bridge voltages, the transformer voltage and the primary and secondary coil currents when the switching frequency is greater than resonant frequency.

FIG. 5 is a transistor gate switching diagram in a forward power LLC frequency modulation mode showing the outer phase angle relationship between the primary and secondary bridge voltages, the transformer voltage and the primary and secondary coil currents when the switching frequency is less than resonant frequency.

FIG. 6 is a transistor gate-switching diagram in the reverse power Dual Active Bridge mode showing the outer phase angle relationship between the primary and secondary bridge voltages, the transformer voltage and the primary and secondary coil currents when the secondary switching leads the primary switching and the switching frequency is greater than the resonant frequency.

FIG. 7 is a transistor gate-switching diagram in the reverse power Dual Active Bridge mode showing the outer phase angle relationship between the primary and secondary bridge voltages, the transformer voltage and the primary and secondary coil currents when the primary switching leads the secondary switching and the switching frequency is less than the resonant frequency.

Like reference symbols in the various drawings indicate like elements.

### DETAILED DESCRIPTION

Electric vehicle (EV) battery chargers are required to convert the alternating current (AC) mains voltage from the electric grid into a direct current (DC) source suitable for charging the vehicle's batteries, which operate on DC voltage. In some implementations, large energy storage elements such as EV battery packs can also be operated in reverse mode, supplying AC power back to a load or utility grid. In this reverse operation, the battery charger converts DC battery voltage into AC mains voltage, enabling the vehicle to function as a backup generator during power outages, supply electricity to off-grid locations such as construction sites, or supplement peak power loads on the utility grid.

Achieving wide voltage range operation at light load, while maintaining high power density and efficiency, presents significant challenges in bidirectional DC/DC converter design. Additionally, bidirectional functionality further complicates these performance targets. Current literature reveals numerous approaches employing combinations of multilevel inverters, series-parallel bank topologies, split- or multi-phase configurations combined with one or multiple resonant tanks and transformers, often with unique control methodologies. While many of these solutions demonstrate technical novelty and efficacy, they frequently suffer from high part counts and increased costs, limiting practical deployment with respect to power density and system complexity.

An alternative approach employs fixed-frequency LLC resonant converters with input voltage control to regulate power transfer. However, these schemes add complexity and cost to the input stage and increase currents within the primary side, impacting efficiency adversely.

Referring to FIG. 1, a conventional charging system of an electric vehicle 10 includes an AC-DC converter 12 interfacing with the electric grid (not shown) through a vehicle charging plug. This converter features a front-end power factor correction (PFC) circuit (not shown), which processes the AC mains power to supply a regulated, fixed DC bus voltage with low harmonic distortion. The limited output voltage imposed by utility constraints necessitates a secondary stage DC-DC converter 14 to precisely regulate current and voltage for charging one or more batteries 16.

This secondary DC-DC converter 14 may take the form of an LLC resonant converter, a phase-shifted full-bridge converter, or a hybrid combination thereof, controlled by a processing device or controller hardware that modulates operational switching frequency or phase shift. A controller 18, being a processing device 20 or a hardware processing device 22, controls the DC-DC converter 14 to a modulated operational frequency.

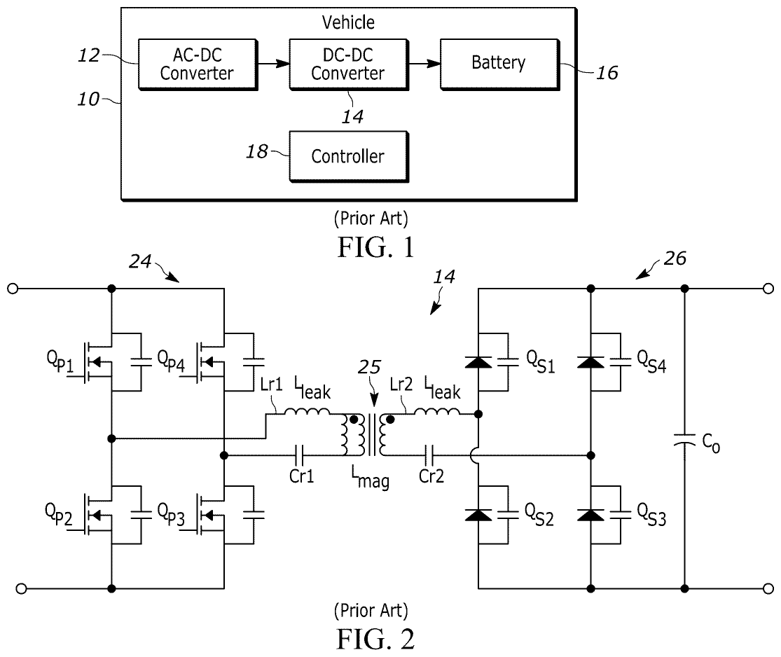

With reference to FIG. 2, a conventional symmetrical CLLC resonant converter 14 has an inductor Lr1 (Lleak) and capacitor Cr1 forming one resonant frequency and a parallel inductance Lmag (magnetizing inductance) forming a second resonant frequency on a primary side 24 of the transformer 25 (T1). The secondary side 26 includes series inductor Lr2 (Lleak) and capacitor Cr2. This topology lends itself well to an isolated converter where the isolating transformer integrates these inductances into one component for a lower cost, higher power density converter (leakage and magnetizing inductance).

In order to have a wide operating range with load independent Zero Voltage Switching (ZVS), it is desirable to configure this isolating transformer 25 with a step-down turns ratio. This feature narrows the required frequency control range and utilizes magnetizing current to maintain load-independent ZVS effectively. However, when the converter 14 is reversed, e.g., operating as a driver from the battery 16 to the grid (discharge mode)—this transformer ratio consequently induces undesirable high-frequency modulation to achieve appropriate attenuation.

Adding secondary-side resonant capacitors to form an asymmetrical CLLC resonant tank introduces forward-mode voltage drops, limiting the effective voltage range for a given frequency modulation. Hence, placing all series or leakage inductance on the secondary side is normally undesirable.

Removing the secondary side resonant capacitor Cr2 and replacing it with leakage inductance exclusively on the secondary side mitigates some of these limitations. The reflected inductance to the primary allows resonant operation in the charging direction while inherently enabling an optimized phase-shifted dual-active bridge (DAB) operation in the discharge direction.

Separating the leakage inductance from the main transformer structure permits improved transformer power density and efficiency, including greater winding packing factors and interleaved windings that reduce proximity losses. A high leakage transformer configuration is made possible by separating the windings into different chambers and controlling the size of the winding slot. This inherently results in larger construction with potentially higher losses.

One challenge with removing the secondary side capacitor Cr2 is the potential for DC flux accumulation and transformer saturation. Passive mitigation using DC blocking capacitors is possible but incurs size and cost penalties. Instead, an active approach involves measuring the peak current on the secondary side 26 and dynamically adjusting pulse-width modulation timings to balance the flux. Existing state-of-the-art current sensing involves two measurements: one on the battery side of the LC output filter for DC current control, and one on the transformer or AC side for over-current detection, typically performed with a current transformer (CT). Alternatively, one sensor on the AC side can be implemented that measures both DC current and AC current with the use of separate passive or active filters and thus simultaneously fulfilling functional safety requirements for dual analog-to-digital converters.

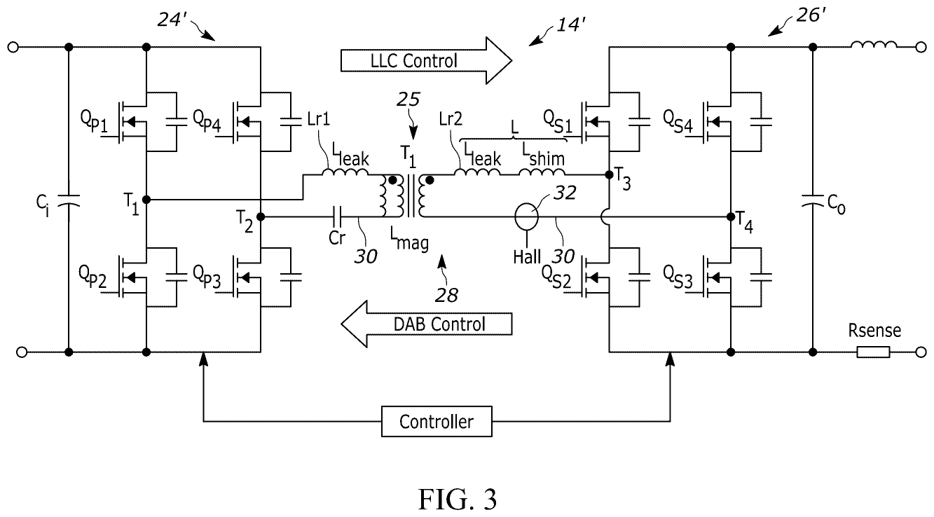

FIG. 3 illustrates an exemplary bidirectional DC-DC converter 14′ implementing LLC resonant frequency modulation control in the charging (forward) direction and Dual Active Bridge control in the discharging (reverse) direction, in accordance with an embodiment of the invention. The converter 14′ is configured to be connected between an input DC power source and a load (both not shown). The input DC power source is preferably an energy storage device such as rechargeable batteries, fuel cells and/or the like. The load represents the power consumed by a circuit coupled to the converter 14′. Alternatively, the load may refer to downstream converters coupled to the output of the converter 14′.

The converter 14′ comprises a primary side inverter 24′, a resonant tank and transformer circuit 28, and a secondary side rectifier 26′. The primary side inverter 24′, the resonant tank and transformer circuit 28, and the secondary side rectifier 26′ are coupled to each other and connected in cascade between the input DC power source and the load.

The primary side inverter 24′ is coupled at the primary side of the resonant tank and transformer circuit 28 and converts a DC voltage into a rectangular waveform with an alternating voltage polarity across the resonant tank and transformer circuit 28. The primary side inverter 24′ is a full-bridge resonant converter but can operate in a half-bridge mode.

The resonant tank and transformer circuit 28 includes a resonant tank 30 and a transformer 25. The transformer 25 provides electrical isolation between its primary side and secondary side. In accordance with an embodiment, the transformer 25 may be formed of two transformer windings, namely a primary transformer winding and a secondary transformer winding. Alternatively, the transformer may have a center tapped secondary so as to have three transformer windings including a primary transformer winding, a first secondary transformer winding and a second secondary transformer winding.

The resonant tank 30 of the resonant tank and transformer circuit 28 is coupled to the primary winding of the transformer 25. Alternatively, the resonant tank 30 may be coupled at the secondary side of the transformer 25 between the secondary winding and the secondary side rectifier 26′. The resonant tank 30 may be implemented in a variety of ways. In some embodiments, the resonant tank includes key resonant elements, namely a leak inductor Lr1, a resonant capacitor Cr, a parallel transformer magnetizing inductance L_{mag} at the primary side of the transformer 25, and a leak inductor Lr2 and a series shim inductor Lshim at the secondary side of the transformer 25. The resonant capacitor Cr forms the resonant capacitance of the resonant tank 30. The resonant capacitor Cr also works as a DC-blocking capacitor for the primary side circuit 24′ of the resonant converter 14′.

In the embodiment, to support active flux balancing, an AC or over-current sensor is provided preferably as a Hall-effect sensor 32 capable of measuring both AC and DC components, thereby eliminating the need for DC blocking capacitors on the secondary side 26′. The DC battery current control loop operates at low bandwidth focusing on stability, while flux balancing must operate with higher, well-separated bandwidth for rapid dynamic compensation.

The secondary side rectifier 26′ is coupled to the secondary side of the resonant tank and transformer circuit 28, and converts an alternating polarity waveform received from the output of the resonant tank and transformer circuit 28 to a single polarity waveform. The secondary side rectifier 26′ may have a topology that allows the secondary side rectifier 26′ to operate at multiple operating modes. For example, the secondary side rectifier 26′ may have a topology of a bridge rectifier and may operate at a full-bridge or half-bridge mode.

The primary side inverter 24′, as shown, is preferably a full-bridge inverter and includes a plurality of primary side switches, namely four switching elements, Q_{P1}, Q_{P2}, Q_{P3} and Q_{P4}. As shown in FIG. 1, a first pair of switching elements Q_{P1} and Q_{P2} are connected in series. A second pair of switching elements Q_{P3} and Q_{P4} are connected in series. The first pair and the second pair of switching elements are connected in parallel. The common node of the switching elements Q_{P1} and Q_{P2} is coupled to a first input terminal T₁ of the resonant tank 28. Likewise, the common node of the switching elements Q_{P3} and Q_{P4} is coupled to a second input terminal T₂ of the resonant tank 28.

In FIG. 3, the switching elements Q_{P1}, Q_{P2}, Q_{P3} and Q_{P4} are configured in the form of a full-bridge inverter, but can be controlled to operate in a half bridge mode. According to some embodiments, switching elements Q_{P1}, Q_{P2}, Q_{P3} and Q_{P4} are preferably implemented as metal oxide semiconductor field effect transistors (MOSFETs).

The secondary side rectifier 26′ converts an AC voltage across the secondary side of the resonant tank 28 into a DC voltage. As shown in FIG. 3, the secondary side rectifier 26′ is preferably a full-bridge rectifier and includes a plurality of secondary side switches, namely four switches Q_{S1}, Q_{S2}, Q_{S3} and Q_{S4}. Switches Q_{S1} and Q_{S2} are connected in series and switches Q_{S3} and Q_{S4} are also connected in series and further coupled to the load. The common node T₃ of the switches Q_{S1} and Q_{S2} is coupled to a second terminal of the secondary winding of the transformer 25 and the common node T₄ of the switches Q_{S3} and Q_{S4} is coupled to a terminal of the series Hall-effect sensor 32. The controller 18 is configured to operate the switches. Capacitors Ci and Co are filter capacitors and can also function as DC link capacitors.

The converter 14′ provides asymmetric LLC LC-type DAB (Dual Action Bridge) converter structure that is configured to operate in an LLC charge mode and a DAB discharge mode. This asymmetric LLC LC-type DAB converter structure 14′ offers several practical advantages including ease of realizing soft switching, a wide load-independent ZVS range, extended high-efficiency operation, improved transformer efficiency and power density, and a wide control range in voltage and current.

Leakage inductance is minimized in this configuration to reduce transformer winding losses and proximity effects. The discrete shim inductor Lshim exclusively on the secondary side 26′ resonates with the primary-side capacitor Cr during LLC operation and simultaneously sets current and power characteristics for the DAB discharge mode while minimizing transformer currents and improving efficiency.

Optimization of the charge mode LLC design parameters involves selecting the optimal transformer turns ratio based on minimum battery voltage requirements, selecting resonant tank parameters (particularly the resonant inductance to capacitance ratio) based on maximum expected loading, determining ideal resonant and switching frequencies, and selecting an appropriate ratio between magnetizing and resonant inductances. Key parameters involved in this optimization are transformer magnetizing inductance (Lmag), resonant inductance (Lr), and resonant capacitance (Cr), with Lr composed of the combination of primary and reflected secondary leakage inductances.

With reference to the formulas below, the discharge mode DAB design optimization involves minimizing reactive circulating currents (i1 and i2) by selecting the maximum power that can be transferred (Pmax), with parameters such as transformer turns ratio (N), primary and secondary voltages (V1 and V2), and switching frequency (Fs) established during LLC optimization. The coupling inductance (L) is then chosen to minimize maximum power transfer. The transformer leakage inductance may then be determined from the LLC optimized resonant inductance Lr and secondary side coupling inductance (L), which is the combination of the secondary leakage inductor Lr2 and the additional shim inductor (Lshim).

$$P = \frac{{NV}_{1} {V}_{2} φ ( π - \vert φ \vert )}{2 {π}^{2} {F}_{s} L}$$

$${P}_{max} = \frac{{NV}_{1} {V}_{2}}{8 {F}_{s} L}$$

$${i}_{1} = 0.5 ( 2 φ - ( 1 - N \frac{{V}_{2}}{V 1} ) π ) \frac{{V}_{1}}{ω L}$$

$${i}_{2} = 0.5 ( 2 N \frac{{V}_{2}}{V1} φ + ( 1 - N \frac{{V}_{2}}{V1} ) π ) \frac{{V}_{1}}{ω L}$$

Several positive trade-offs arise from this design approach. Transformer design is less reliant on high intrinsic leakage inductance, allowing the use of interleaved coils and improved winding techniques to minimize proximity losses. As a result, transformer size can be reduced, and secondary resonant capacitors are eliminated, simplifying the overall converter design.

A noted negative trade-off is the introduction of an additional discrete coupling or shim inductor component. This can be combined with the transformer by extending the secondary winding around an additional core element.

### Converter Architecture and Control Methodology

The converter 14′ comprises a primary full-bridge inverter coupled to a primary DC-link and a secondary full-bridge inverter coupled to a secondary DC-link. These bridges are galvanically isolated via an isolation transformer designed with a particular leakage inductance to improve bidirectional power density and efficiency.

Uniquely, the embodiment features an asymmetrical resonant tank structure, incorporating a series resonant capacitor Cr exclusively on the primary side 24′. A secondary-side coupling inductance (L), representing the equivalent leakage inductance (Lr2) of the transformer plus any added shim inductance (Lshim), is reflected through the transformer turns ratio (n) to the primary side, forming the effective resonant inductance (Lr) in the resonant tank.

The resonant frequency, defined by

$${f}_{r} = \frac{1}{2 π \sqrt{{L}_{r} {C}_{r 1}}} ,$$

prescribes the natural oscillation frequency of the resonant tank and is fundamental to forward power flow control.

Both the full-bridge primary inverter 24″ and the full-bridge secondary rectifier 26′ are configured to operate at nominal fifty percent duty cycles, with transistor gate drive signals staggered by an intentional dead-time interval. This dead-time insertion facilitates zero voltage switching (ZVS) by allowing voltage across switching devices to reduce to near zero before conduction changes, mitigating switching losses, electromagnetic interference, and device stress.

In the forward power flow direction (primary to secondary), the switching frequency is modulated around the resonant frequency fᵣ to regulate output voltage and power transfer efficiently. In the reverse direction (secondary to primary), power transfer is modulated primarily via the outer phase shift angle between the voltage waveforms of the two full bridges at a generally fixed switching frequency. This phase angle acts as the principal control variable governing power transfer magnitude and direction, with zero phase indicating no net transfer and deviation in either direction enabling bidirectional flow.

To optimize performance under light-load or low-current conditions, the converter 14′ employs inner phase-angle modulation (also called triple phase shift). This modulation dynamically adjusts intra-bridge timing to reduce circulating reactive currents and extend the ZVS operational envelope. Inner phase-angle modulation works synergistically with frequency modulation in forward power flow and outer phase-angle modulation in reverse flow to maximize efficiency and reliability.

Voltage and current scaling between primary and secondary sides adheres to the transformer turns ratio N. Reflected voltages and currents influence resonant tank behavior and switching waveforms synergistically in both power flow directions.

The converter can also support buck and boost operation in the reverse direction through dual-mode modulation. When the switching frequency fₛ exceeds the resonant frequency fᵣ, the secondary bridge leads the primary bridge in phase, producing an inductive load condition suitable for boosting the voltage. Conversely, when fₛ<fᵣ, the primary bridge leads, creating a buck characteristic that reduces voltage. This flexibility allows stable and efficient voltage regulation across varying load and supply conditions or in cooperation with optimally design LLC resonant tank parameters for the forward direction through frequency modulation.

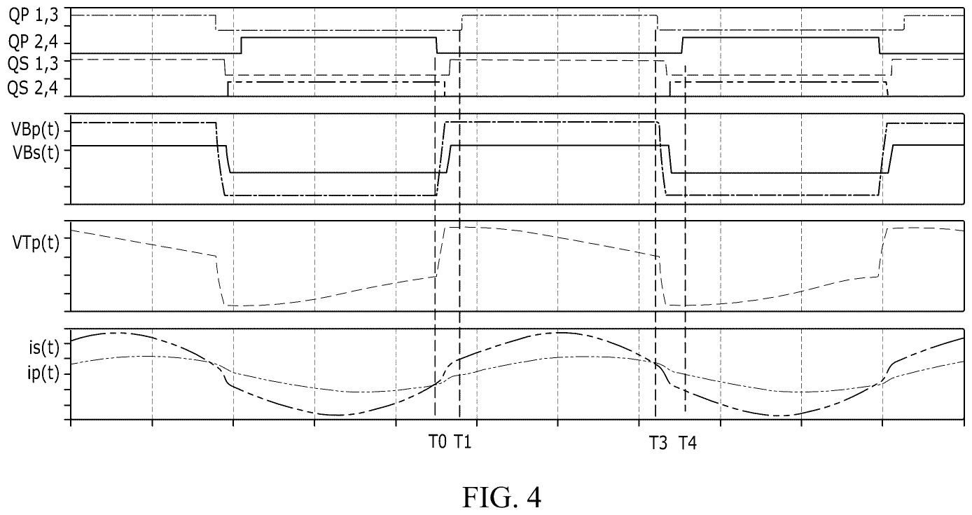

FIG. 4 is a transistor gate switching diagram in a forward power LLC frequency modulation mode where switching frequency wₛ is greater than resonant frequency wᵣ and primary bridge voltage VBp(t) transitions at T0 when Qp2,4 turn off, providing ZVS to Qp1,3 during dead time T1-T0. Qs2,4 and Qs1,3 switch-gating are in synchronous rectification. Transformer voltage VTp(t) is in resonance with the LLC tank where the desired buck voltage is being regulated.

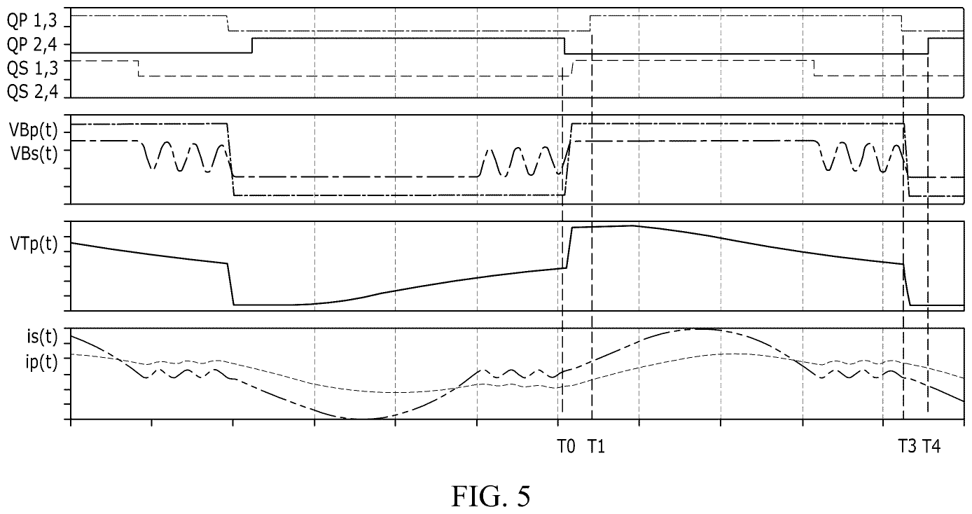

FIG. 5 is a transistor gate switching diagram in a forward power LLC frequency modulation mode where switching frequency wₛ is less than resonant frequency wᵣ and primary bridge voltage VBp(t) transitions at T0 when Qp2,4 turn off, providing ZVS to Qp1,3 during dead time T1-T0. QS2,4 and Qs1,3 switch-gating are in synchronous rectification. Transformer voltage VTp (t) is in resonance with the LLC tank where the desired boost voltage is being regulated.

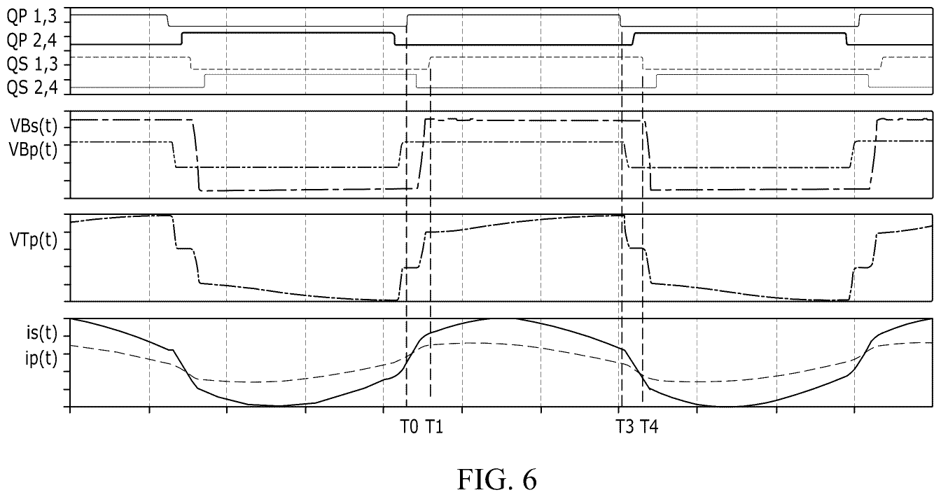

FIG. 6 is a transistor gate switching diagram in the reverse power Dual Active Bridge mode where secondary bridge voltage VBs (t) leads primary bridge voltage VBp (t) resulting from transistors Qs1,3 turn on at T0 and transistors Qp1,3 turn on at T₁ where outer phase angle is described by wₛ(T1-T0). Switching frequency wₛ is greater than resonant frequency wᵣ.

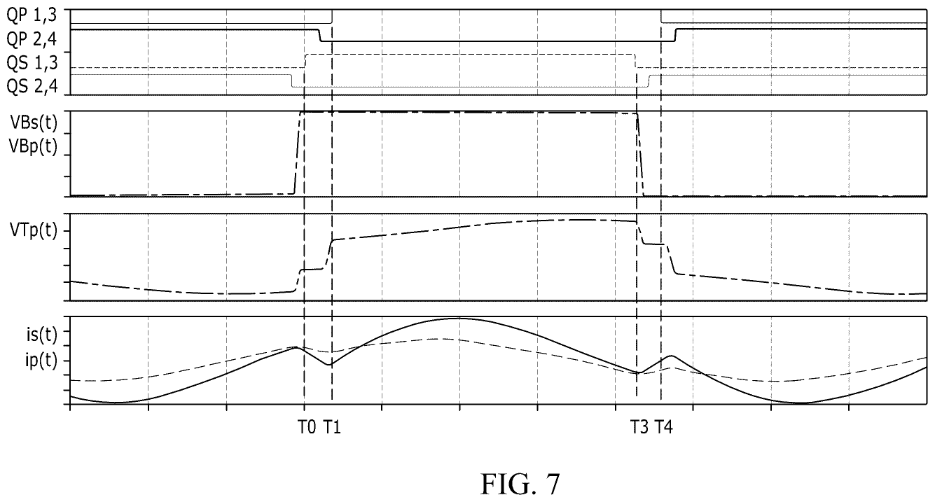

FIG. 7 is transistor gate-switching diagram in the reverse power Dual Active Bridge mode where primary bridge voltage VBp(t) leads secondary bridge voltage VBs(t) resulting from transistors Qp1,3 turn on at T0 and transistors Qs1,3 turn on at T₁ where outer phase angle is described by -wₛ(T1-T1). Switching frequency wₛ is less than resonant frequency wᵣ.

Thus, the embodiment provides a series-resonant dual active bridge (SR-DAB) converter architecture featuring an asymmetrical resonant tank with a series resonant capacitor Cr on the primary side 24′ and a discrete coupling inductor (Lshim) on the secondary side 26′. The converter 14 employs a hybrid modulation control scheme that combines resonant frequency modulation during forward power flow and outer phase-angle modulation during reverse power flow, augmented by inner phase-angle modulation and transistor dead-time insertion to enable wide-range zero voltage switching (ZVS). This architecture and control strategy collectively yield high power density, extended voltage regulation range, enhanced efficiency, and reduced reactive circulating currents compared to conventional DAB topologies.

In some transformer configurations optimized for the invention, most leakage inductance may be contained on the secondary side 26, minimizing the need for the additional shim inductor (Lshim).

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A bidirectional series-resonant power converter comprising:
a transformer;
an asymmetrical resonant tank electrically coupled to the transformer;
a primary side inverter electrically coupled to a primary side of the transformer; the primary side inverter including a plurality of primary side switches, wherein the resonant tank including at least a resonant capacitor (Cr) exclusively at the primary side,
a secondary side rectifier electrically coupled to a secondary side of the transformer, the secondary side rectifier including a plurality of secondary side switches, wherein the resonant tank further comprises at the secondary side of the transformer, a coupling inductance to facilitate energy storage enabling soft switching and bidirectional power flow, and
a controller configured to control the primary side and secondary side switches to operate the converter in 1) a charge mode by regulating a power flow in a first power flow direction from the primary side to the secondary side and 2) a discharge mode by regulating a power flow in a second power flow direction from the secondary side to the primary side.

2. The converter of claim 1, wherein the coupling inductance comprises at least a transformer leakage inductance and a discrete coupling inductor (Lₛₕᵢₘ) disposed exclusively on the secondary side of the transformer.

3. The converter of claim 1, wherein the converter is configured to operate in a hybrid modulation control scheme that combines resonant frequency modulation during forward power flow and outer phase-angle modulation during reverse power flow.

4. The converter of claim 2, wherein the discrete coupling inductor is configured to be reflected to the primary side by n²Lₛₕᵢₘ, where n is the transformer turns ratio, together defining an effective resonant inductance Lᵣ, wherein a resonant frequency fᵣ=1/2π\sqrt{LᵣCᵣ} determines a resonant tank operation.

5. The converter of claim 1, wherein the primary side inverter and the secondary side rectifier are configured to operate in a full-bridge mode.

6. A bidirectional series-resonant power converter comprising:
a transformer;
an asymmetrical resonant tank electrically coupled to the transformer;
a primary side inverter electrically coupled to a primary side of the transformer; the resonant tank including at least a resonant capacitor (Cr) exclusively at the primary side, and
a secondary side rectifier electrically coupled to a secondary side of the transformer,
wherein the resonant tank further comprises at the secondary side of the transformer, a coupling inductance to facilitate energy storage enabling soft switching and bidirectional power flow and a sensor configured to measure both AC and DC components, thereby eliminating the need for DC blocking capacitors on the secondary side.

7. The converter of claim 6, wherein the coupling inductance comprises at least a transformer leakage inductance and a discrete coupling inductor (L_“shim”).

8. The converter of claim 6, wherein the sensor is a Hall-effect sensor.

9. The converter of claim 6, wherein the resonant tank further comprises at the primary side, a transformer leakage inductance and a transformer magnetizing inductance L_{mag}.

10. The converter of claim 6, wherein the converter is configured to operate in a hybrid modulation control scheme that combines resonant frequency modulation during forward power flow and outer phase-angle modulation during reverse power flow.

11. The converter of claim 7, wherein the discrete coupling inductor is configured to be reflected to the primary side by n²Lₛₕᵢₘ, where n is the transformer turns ratio, together defining an effective resonant inductance Lᵣ, wherein a resonant frequency
$${f}_{r} = \frac{1}{2 π \sqrt{{L}_{r} {C}_{r}}}$$
determines a resonant tank operation.

12. The converter of claim 6, wherein the primary side inverter and the secondary side rectifier are configured to operate in a full-bridge mode.

13. A method of operating a bidirectional series-resonant power converter, the converter comprising a transformer; an asymmetrical resonant tank electrically coupled to the transformer; a full-bridge primary side inverter electrically coupled to a primary side of the transformer; the resonant tank including at least a resonant capacitor (Cr) exclusively at the primary side, and a secondary side rectifier electrically coupled to a secondary side of the transformer, wherein the resonant tank further comprises at the secondary side of the transformer, a coupling inductance to facilitate energy storage enabling soft switching and bidirectional power flow, the method comprising:
operating the full-bridge primary side inverter and the full bridge secondary side rectifier at a nominal 50% duty cycle with a transistor dead-time t_{d} introduced between complementary gate signals to facilitate zero voltage switching (ZVS).

14. The method of claim 13, further comprising:
regulating a power flow in a first power flow direction from the primary side to the secondary side via switching frequency modulation fₛ varying near a resonant frequency fᵣ.

15. The method of claim 13, further comprising:
regulating a power flow in a second power flow direction from the secondary side to the primary side by controlling an outer phase angle φ between the full-bridge primary side inverter and the full bridge secondary side rectifier at a fixed switching frequency.

16. The method of claim 14, further comprising:
when a switching frequency fₛ>fᵣ, the secondary side rectifier leads the primary side inverter to providing a boost voltage characteristic, and
when fₛ<fᵣ, the primary bridge leads the secondary bridge providing a buck voltage characteristic.

17. The method of claim 14, further comprising:
selectively implementing inner phase-angle modulation on the full-bridge primary side inverter and/or the full bridge secondary side rectifier during low-current or light-load operation to reduce circulating reactive currents and extend the ZVS operational range, cooperating with frequency modulation in the first power flow direction and outer phase-angle modulation in the second power flow direction.

18. The method of claim 13, further comprising:
ensuring that voltages on primary and secondary sides of the transformer obey a transformer turns ratio n, and reflected voltages and currents are accounted for in controlling resonant frequency and switching waveforms to optimize conduction loss and converter stress.

19. The method of claim 13, wherein the coupling inductance comprises at least a transformer leakage inductor and a discrete coupling inductor (L_“shim”).
